(19) United States
(12) Patent Application Publication
(10) Pub. No.: US 2006/0164932 A1
(43) Pub. Date: Jul. 27, 2006

(54) MEDIA CONTROL UNIT FOR PROVIDING INTERACTIVE EXPERIENCE WITH AUDIOVISUAL CONTENT OF DVD

(75) Inventors: John P. Kavanagh, Menlo Park, CA (US); Craig S. Gravina, Farmington, CT (US); Martin McDonald, Menlo Park, CA (US); Geoffrey M. Lyon, Menlo Park, CA (US)

Correspondence Address: TILLMAN WRIGHT, PLLC, P.O. BOX 471581, CHARLOTTE, NC, 28247, US

(73) Assignee: BRIGHT ENTERTAINMENT LIMITED, London (GB)

(21) Appl. No.: 11/163,580

(22) Filed: Oct. 24, 2005

Related U.S. Application Data
(63) Continuation-in-part of application No. 10/247,271, filed on Sep. 18, 2002, now Pat. No. 7,003,598.
(63) Continuation-in-part of application No. 11/045,510, filed on Jan. 28, 2005.

(51) Int. Cl. G11B 21/08

(52) U.S. Cl. 369/30.28; 369/30.01

(57) ABSTRACT

A method performed by a media control unit provides an interactive experience with audiovisual content of a DVD played by a multimedia player and includes: receiving a user-generated signal representative of a response of the user to a first video sequence of the audiovisual content of the DVD presented to the user; in response to the user-generated signal, determining media control signals for communicating to the multimedia device that will result in the multimedia player playing an appropriate video sequence of the audiovisual content of the DVD representing a reply to the user's response; and wirelessly communicating, for receipt by the multimedia device, the determined media control signals, whereby the appropriate video sequence is played in reply to the user's response.

### CROSS REFERENCE TO RELATED APPLICATIONS

The present application is a continuation-in-part of, and claims priority under 35 U.S.C. 120 to, each of: U.S. patent application Ser. No. 10/247,271, published as U.S. Patent Application Publication No. 2004/0054826 A1, and now U.S. Pat. No. ______, each of which is hereby incorporated herein by reference; and U.S. patent application Ser. No. 11/045,510, published as U.S. Patent Application Publication No. ______, each of which is hereby incorporated herein by reference.

### FIELD OF THE INVENTION

The field of the invention comprises electronic multimedia devices that provide interactive experiences with audiovisual content.

### BACKGROUND OF THE INVENTION

The video game industry has developed over recent decades into a rather mature industry in which production costs of a single video game can rival production costs of motion pictures produced by major studios. In addition, growth in the performance of personal computers is currently being driven by the demanding performance requirements of currently available video games played on personal computers. Dedicated game stations are currently more powerful than the most powerful desktop computers available even a few years ago.

Of course, commensurate with this processing power is substantial cost. In addition, such games require substantial attention and focus-frequently involving very active use of multiple user input devices while seated at a computer workstation. For some, particularly young children or casual game players, current gaming platforms are too expensive and/or too demanding of focused attention for simple, relaxing play. In short, there appears to be a substantial lack of and consequent need for low-cost alternatives to video game devices currently available.

One or more aspects of the invention addresses this need.

### SUMMARY OF THE INVENTION

The present invention first is summarized by reference to one or more preferred embodiments, which may be more readily understood at this point in the present disclosure. Thereafter, broader aspects of the present invention are summarized as found in one or more claims. Furthermore, to the extent that each claim serves to define an invention, the phrase “present invention” is intended generally to refer to an invention of the claims but not necessarily to all of the inventions of the claims. An “aspect of the present invention” as used herein is generally intended to refer to an invention of an independent claim. Finally, reference to “the claims” is generally intended to refer, collectively, to the claims of the present application as well as to the claims of any application related to the present application through a claim of priority.

According to one or more preferred embodiments of the present invention, a media control unit provides an interactive experience with audiovisual content by controlling presentation of the audiovisual content on standard home entertainment equipment. The media control unit executes an interactive computer program, such as a computer game, and communicates standard infrared (IR) remote control signals to cause standard home entertainment equipment to provide output to the user as part of the interactive program. The standard home entertainment equipment can be a standard digital video disk (DVD) player and a digital video disk which includes rich audiovisual content for presentation to the user as directed by the portable computer device. The interactive program can be executed by the portable computer device from a memory device that contains both computer-executable instructions defining the behavior of the interactive program and a layout map of the associated DVD such that the portable computer device can select content from the associated DVD for presentation to the user. In response to actions of the user, the portable computer device can emit remote control signals representing button combinations to allow for controlled navigation of the DVD, thus providing a higher level of interactivity than previously attainable with conventional control of DVD players. Because the media control unit does not include the electronic components for presenting the audiovisual content but, instead, only the components for controlling such presentation in accordance with predetermined logic, the media control unit may comprise a simple and inexpensive portable computer device.

With regard to particular aspects and features of the present invention, of which there are many, a method performed by a media control unit for providing an interactive experience with audiovisual content of a DVD that is played by a multimedia player. The method includes the steps of: (a) receiving, by the media control unit, a user-generated signal that is representative of a response of the user to a first video sequence of the audiovisual content of the DVD that is presented to the user; (b) in response to the user-generated signal received in said step (a) determining, by the media control unit, one or more media control signals to communicate to the multimedia device that will result in the multimedia player playing an appropriate video sequence of the audiovisual content of the DVD in order to provide to the user an interactive experience with the audiovisual content of the DVD, the appropriate video sequence being one of a plurality of possible video sequences of the audiovisual content of the DVD that are available for presentation to the user subsequent to the first video sequence; and (c) wirelessly communicating, by the media control unit, for receipt by the multimedia device, the one or more media control signals determined in said step (b) for playing of the appropriate video sequence. As a result, the appropriate video sequence from the DVD is played by the multimedia player in reply to the response of the user in said step (a) and the interactive experience with the audiovisual content of the DVD is provided to the user.

In a feature of this aspect, the step (b) is performed in accordance with logic for navigating the audiovisual content of the DVD based on the user-generated signal received in said step (a), whereby the interactive experience with the audiovisual content of the DVD is provided.

In another feature, machine-executable instructions represent the logic for navigating the audiovisual content of the DVD, the machine-executable instructions being specific to the DVD that is played by the multimedia player. A memory device that is removably coupled to the media control unit preferably contains the machine-executable instructions representing the logic for navigating the audiovisual content of the DVD, and the media control unit reads the machine-executable instructions the from the memory device.

In another feature, the method further includes the step of detecting the insertion of the removable memory device into a card reader of the media control unit and reading, by the media control unit, data from the removable memory device upon the detected insertion of the removable memory device into the card reader of the media control unit.

In still yet another feature, the one or more media control signals determined in said step (b) comprise standard infrared DVD remote control signals. Furthermore, the one or more media control signals determined in said step (b) are wirelessly communicated via infrared transmissions, or the one or more media control signals determined in said step (b) are wirelessly communicated via radio frequency transmissions to an RF/IR repeater unit.

In another feature of this aspect, the method further includes, after performing said steps (a)-(c), the steps of: (d) receiving, by the media control unit, a user-generated signal that is representative of a response of the user to presentation of the appropriate video sequence for which the media control signals were determined in said step (b); (e) in response to the user-generated signal received in said step (d), determining, by the media control unit, one or more media control signals to communicate to the multimedia device that will result in the multimedia player playing a subsequent appropriate video sequence of the audiovisual content of the DVD in order to continue to provide to the user an interactive experience with the audiovisual content of the DVD, the subsequent appropriate video sequence being one of a plurality of possible video sequences of the audiovisual content of the DVD that are then available for presentation to the user subsequent to the first video sequence; and (f) wirelessly communicating, by the media control unit, for receipt by the multimedia device, the one or more media control signals determined in said step (e) for playing the subsequent appropriate video sequence. As a result, the subsequent appropriate video sequence from the DVD is played by the multimedia player in reply to the response of the user of said step (d), and the interactive experience with the audiovisual content of the DVD is continued to be provided to the user. Moreover, the plurality of possible video sequences of said step (b) may be different from the plurality of possible video sequences of said step (e). The received user-generated signal of said step (a) also may be identical to said received user-generated signal of said step (d), while the one or more media control signals wirelessly communicated in said step (c) are different from the one or more media control signals wirelessly communicated in said step (f). The subsequent appropriate video sequence also may be dependent upon the detected presence of said step (b), and/or may be dependent upon the appropriate video sequence of said step (b).

In another aspect of the invention, a method performed by a game control unit for providing an interactive gaming experience with audiovisual content of a DVD that is played by a multimedia player includes the steps of: (a) receiving, by the game control unit, a user-generated signal that is representative of an action of the user in a game; (b) in response to the user-generated signal received in said step (a), determining, by the game control unit, one or more game control signals to communicate to the multimedia device that will result in the multimedia player playing an appropriate video sequence of the audiovisual content of the DVD in order to provide to the user an interactive gaming experience with the audiovisual content of the DVD, the appropriate video sequence being one of a plurality of possible video sequences of the audiovisual content of the DVD that are available for presentation to the user subsequent to the first video sequence, the appropriate video sequence being dependent upon a detected presence by the game control unit of an object that is removably coupled to the game control unit; and (c) wirelessly communicating, by the game control unit, for receipt by the multimedia device, the one or more game control signals determined in said step (b) for playing of the appropriate video sequence. As a result, the appropriate video sequence from the DVD is played by the multimedia player in response to the action of the user in the game in said step (a), and the interactive gaming experience with the audiovisual content of the DVD is provided to the user.

In a feature of this aspect, the method further includes: (d) receiving a user-generated signal that is representative of a response of the user in the game to presentation of the appropriate video sequence for which the game control signals were determined in said step (b); (e) in response to the user-generated signal received in said step (d), determining, by the game control unit, one or more game control signals to communicate to the multimedia device that will result in the multimedia player playing a subsequent appropriate video sequence of the audiovisual content of the DVD in order to continue to provide to the user the interactive gaming experience with the audiovisual content of the DVD, the subsequent appropriate video sequence being one of a plurality of possible video sequences of the audiovisual content of the DVD that are then available for presentation to the user subsequent to the first video sequence; and (f) wirelessly communicating, by the game control unit, for receipt by the multimedia device, the one or more game control signals determined in said step (e) for playing the subsequent appropriate video sequence; whereby the subsequent appropriate video sequence from the DVD is played by the multimedia player in response to the action of the user in the game in said step (d), and the interactive gaming experience with the audiovisual content of the DVD is continued to be provided to the user

In other aspects of the invention, media control units perform methods in accordance with the aforementioned aspects of the present invention. Each of the media control units may be a remote control unit; a game control unit, and/or a handheld unit. The present invention further includes the various possible combinations and permutations of the aforementioned aspects and features, as well as systems including the same.

### BRIEF DESCRIPTION OF THE DRAWINGS

FIG. 1 is a block diagram illustrating a game control unit, DVD player, television, DVD and associated memory device in accordance with the present invention.

FIG. 2 is a block diagram showing the game control unit of FIG. 1 in greater detail.

FIG. 3 is a block diagram showing organization of data on the memory device of FIG. 1.

FIG. 4 is a logic flow diagram of the initialization of the game control unit of FIG. 2 during game play start-up.

FIG. 5A and FIG. 5B together illustrate a logic flow diagram of game play of a quiz-type game.

FIG. 6 is a chart of sample game types that may be implemented in accordance with the present invention.

FIG. 7 is an illustration of a conventional remote control unit.

FIG. 8 is an illustration of user-input device components of the game control unit of FIG. 2.

FIG. 9 is a table of standard remote control buttons of a remote control unit for a DVD player.

### DETAILED DESCRIPTION

As a preliminary matter, it will readily be understood by one having ordinary skill in the relevant field (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It furthermore is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at lease one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.”

Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

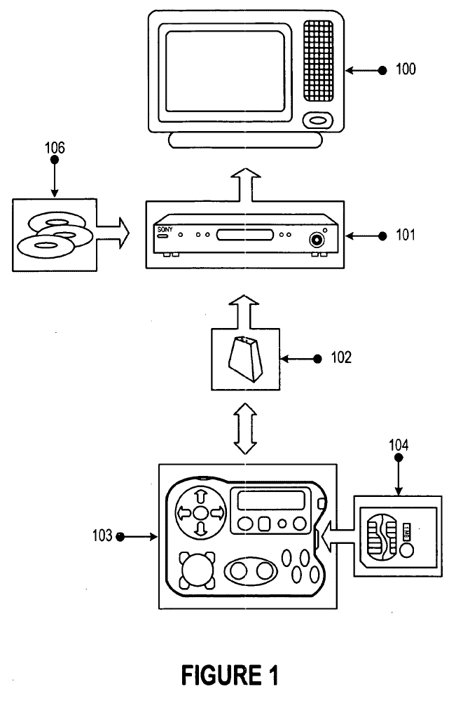

In accordance with one or more preferred embodiments of the present invention, a game control unit 103 (FIG. 1) uses existing multimedia infrastructure such as a conventional DVD player 101 for display of multimedia content in accordance with game logic stored on a memory device 104. As a result, game control unit 103 can be very simple and relatively inexpensive yet, in combination with currently ubiquitous multimedia infrastructure, can provide fairly sophisticated interactive game play with a very rich multimedia experience for the user. Specifically, DVD 106 includes audio/visual clips and other content which represent portions of a multimedia presentation of game play. Collectively, the clips and other content of DVD 106 represent all possible permutations of the multimedia presentation of the game programmed on memory device 104. During execution of the game programmed on memory device 104, game control unit 103 issues remote control signals to DVD player 101 to play specific clips of multimedia content in succession to present a full, multimedia, interactive game play experience to the user. Thus, the full multimedia capabilities of currently available and relatively ubiquitous DVD players and televisions to supply the rich, multimedia experience of video games while only at the cost of producing a relatively simple game control unit 103. Such provides a rich video game play experience at a cost substantially below that of currently available game consoles and personal computers.

As described more completely below, game control unit 103 includes a general purpose processor for executing computer instructions stored on memory device 104. Memory device 104 is intended to be a simple and very affordable low memory (approximately 1 megabit) device. However, it should be appreciated that other memory devices can be used to provide computer instruction for game control unit 103. Illustrative examples include ubiquitous flash memory devices such as compact flash cards, smart media cards, memory sticks, multimedia cards, secure digital cards, and USB portable memory “drives” as well as floppy disks, CDROMs in various sizes and shapes, and wireless and wired network connections to other computers. In this illustrative embodiment, memory device 104 is shown to be a smart media card.

Memory device 104 is associated with a separate digital storage medium on which is stored display content associated with a game program stored on memory device 104. Such a digital storage medium is represented by DVD 106 in this illustrative embodiment and memory device 104 can be packaged for distribution along with DVD 106.

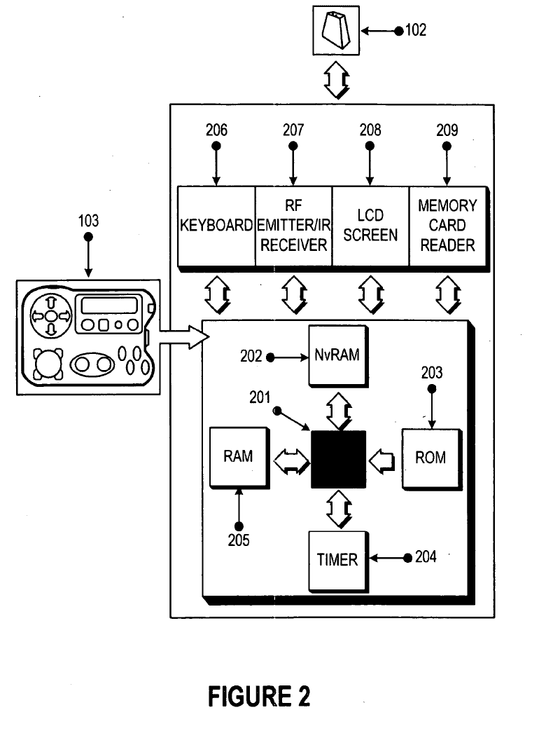

Game control unit 103 is shown in greater detail in FIG. 2. CPU 201 is a low-cost, low power consumption 8-bit processor unit. At power up, CPU 201 performs a standard bootstrap process as defined by read-only memory (ROM) 203. ROM 203 also contains a list of predefined DVD-player IR control codes and a configuration program to re-program the remote unit 103 by an IR receiver 207. As described more completely below, game control unit 103 mimics a remote control of DVD player 101 to cause playback of multimedia content on DVD 106 through DVD player 101 to provide a rich multimedia game play experience in accordance with the program stored on memory device 104.

After booting, CPU 201 checks a non-volatile random access memory (NvRAM) module 202 for system patches that are delivered via the removable memory card module. In this way, memory device 104 can be used as a transport for updates to the operational programming of game control unit 103. Memory device 104 is accessed through a memory card reader 209. New DVD player configuration codes could also be delivered in this way. In this illustrative embodiment, NvRAM module 202 is a relatively small cache that retains its contents when the power is switched off and is used to store configuration information such as code which identifies the particular model of DVD player 101 such that control thereof is properly implemented without requiring re-initialization of game control unit 103.

Game control unit 103 also includes random-access memory (RAM) 205 which is volatile RAM in this illustrative embodiment to provide a fast-access workspace for data during operation of game control unit 103. During operation, CPU 201 determines the specific model of DVD player 101 as stored in NvRAM 202 and retrieves the current IR code configuration from the ROM 203 and stores the IR code configuration into RAM 205 for faster execution during runtime operations. RAM module 205 serves as a small cache used during program execution. It should be appreciated that the entire functionality of the foregoing description of game control unit 103 can be available as an integrated ASIC solution at a reasonable cost.

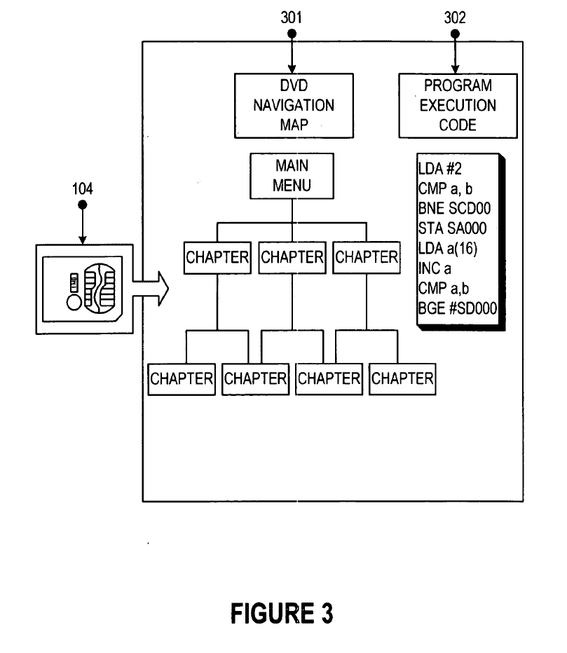

Through memory card reader 209, CPU 201 accesses data stored on memory device 104. This data contains a code 302 (FIG. 3) and a DVD map 301 which are specific to DVD 106. Code 302 is a computer program which includes computer instructions and data which specify a behavior of game control unit 103 (FIG. 2). DVD map 301 is a navigation map specifying hierarchical relationships between various chapters of the multimedia content stored on DVD 106. The organization of multimedia content stored on a DVD is known and is described below in some detail for the benefit of the reader. Briefly, the multimedia content of a DVD is divided into chapters which are organized hierarchically. Users who have viewed multimedia content of a DVD and have selected episodes or various edits and/or commentary using a DVD remote control have followed the rudimentary logic and hierarchical chapters of multimedia content stored on a DVD.

Game control unit 103 detects insertion of memory device 104 into memory card reader 209 and reads code 302 (FIG. 3) and DVD map 301. CPU 201 (FIG. 2) commences execution of the code supplied on memory device 104. During such execution, CPU 201 (i) processes signals received by physical manipulation of keyboard 206 by the user, (ii) navigates the DVD map 301 of memory device 104, and (iii) provides game play functionality such as timers, random number generation and scoring. Game control unit 103 includes an LCD screen 208 through which additional game play feedback is presented to the user. In an alternative embodiment, LCD screen 208 is omitted and game control unit 103 relies solely on the TV display for visual feedback of the executing program.

Keyboard 206 (FIG. 2) is the primary user input device of game control unit 103 and can mimic the main functions of a standard DVD remote control and additionally provides application-specific assignable keys as well as custom key operation. Keyboard 206 can also provide visual feedback confirmation of user input or as directed by the content under CPU 201 control. Such visual feedback can be in the form of keys which are controllably lighted in accordance with computer instructions executed by CPU 201. The layout of keyboard 206 is also designed to facilitate user-interaction with the displayed content rather than to facilitate disc navigation as found on a standard remote control. Specifically, a number of the keys of keyboard 206 are arranged to represent directional keys, namely, up, down, left, and right. Alternatively, keyboard 206 can include a directional rocker key which can be used in a manner similar to a joystick. In this illustrative embodiment, a number of keys of keyboard 206 are also visually configurable by the use of plastic overlays which specify functions of overlaid keys in the context of the game represented by program 302. Such overlays can be packaged with DVD 106 and memory device 104.

In one embodiment, game control unit 103 includes an infrared (IR) emitter for transmitting remote control signals to DVD player 101. However, since IR transmission of control signals generally requires line-of-sight travel of the control signals, as understood by anyone feeling the need to point a remote control directly at a controlled device, radio frequency (RF) control signals are preferred since game control unit 103 is likely to be jostled about during the excitement of game play. Accordingly, a RF/IR remote control repeater 102 is used to receive RF control signals from game control unit 103 and forwards the control signals as IR signals to DVD player 101. RF/IR remote control signal repeaters are generally known and are not described further herein. Thus, in this illustrative and preferred embodiment, game control unit 103 includes a combination RF emitter and IR receiver (RF/IR) module 207. RF/IR module 207 transmits RF remote control signals to RF/IR remote control repeater 102 which then repeats the remote control signals as IR signals to DVD player 101. RF/IR module 207 of game control unit 103 is also used to receive IR signals from a remote control unit to learn the specific remote control signals expected and understood by DVD player 101. Learning remote controls are well known and are not described further herein.

FIG. 3 shows illustrative contents of memory device 104. Data stored on memory device 104 is arranged into two distinct areas in this illustrative embodiment, one for DVD map 301 and the other for code 302. DVD map 301 contains data identifying the various multimedia clips stored on DVD 106 and interrelationships therebetween for navigation among the various multimedia clips for playback on DVD player 101.

Organization of content on a DVD comports with a standard implemented by currently available and conventional DVD players such as DVD player 101. Such organization is known and is not described herein except briefly to facilitate understanding and appreciation of the present invention. At the time of authoring of the multimedia content of the DVD, a data set showing the interconnectivity between the various chapters, menu and buttons of the multimedia content is produced by authoring software according to the format laid down by the DVD Book definitions that all consumer DVD players such as DVD player 101 must adhere to. According to the present invention, only the navigational portion of this file is then saved to memory device 104. As a result, DVD map 301 represents the data navigation map without the actual multimedia content being stored on memory device 104 so that the storage area of DVD map 301 is relatively miniscule. For example a DVD such as DVD 106 might contain nine gigabytes (9 GB) of data whereas DVD map 301 can store as little as sixty-four kilobytes (64 kb) or less, i.e., 16,000 times smaller storage space.

Code 302 of memory device 104 contains computer instructions and/or data which collectively define a program for execution by CPU 201 of game control unit 103. Execution of code 302 generally operates as follows: code 302 defines a game, play of which involves user responses to multimedia stimuli presented on television 100 and, in response to the user's response, game control unit 103 transmits remote control signals to cause DVD player 101 to present additional multimedia content to the user for further response. Thus, the content played on DVD player 101 from DVD 106 is selected by game control unit 103 to presented an interactive, integral game experience for the user.

In contrast, a user controlling DVD playback with a conventional remote control directly or indirectly specifies specific content to view. The following example is illustrative of the distinction. Consider that the user is playing a simple quiz game in which the user selects one of multiple choices to answer various questions. In selecting an answer, the user is not specifying to view a brief animation with the message “Correct!” and display of a cumulative score. Instead, the user intends to communicate that she knows which of the selected choices is the correct answer—and the resulting display is exactly that described above: a brief animation with the message “Correct!” and display of a cumulative score. Code 302 includes logic to determine, according to the particular interaction implemented by memory device 104, which clip of multimedia content of DVD 106 is appropriate for display at a particular state in response to the user's response. Thus, the content to be presented is not directly or indirectly selected by the user but instead selected for the user by code 302. In a preferred embodiment, game control unit 103 can also function as a universal remote control to control DVD player 101 in a conventional manner, especially when memory device 104 is not attached to game control unit 103. In addition, to presenting an integral game experience, code 302 can use multimedia content of DVD 106 as reward animations and/or reward musical selections to reward the user with entertainment for reaching various predetermined milestones.

In this illustrative embodiment, DVD Player 101 is a standard consumer DVD player without any modification whatsoever which can be purchased at retail. All multimedia content in this illustrative embodiment is supplied on standard DVD-compliant discs, which enables presentation of the multimedia content with standard consumer DVD players. It should be appreciated that generally any directly accessible storage medium and player device can be used to store content for playback as part of an interactive experience. According to the present invention, it is game control unit 103 that provides the game logic and interactivity.

As described above, interactive game play through game control unit 103 is effected, at least in part, by directing playback of multimedia clips of DVD 106 by emulation of remote control signals to DVD player 101. Generally, DVD navigation is relative, i.e., where a given navigation command takes one within the content of a DVD depends on the current navigational state of DVD player 101 with respect to DVD 106. For example, given a table of contents for playback, a typical remote control enables the user to navigate up, down, left, and/or right to identify an entry in the table of contents. Generally, a remote control does not provide any mechanism by which a user can directly specify a particular clip of multimedia content of a DVD for playback. Such poses challenging problems for an interactive use of DVD content as described herein. One is initial synchronization of the navigational state of DVD player 101 with game control unit 103 such that DVD player 101 and game control unit 103 agree as to which clip of multimedia content is cued up for DVD player 101. Such is important if remote game 103 is to cause DVD player 101 to provide an integral multimedia game experience with a high degree of continuity. Another problem is that of maintaining synchronization throughout game play—such that continuity of the game play experience is maintained throughout.

To maintain synchronization between game control unit 103 and DVD player 101, all emulated remote control signals sent by game control unit 103 are routed through a base unit 102 which converts the RF signal emitted by the game control unit 103 into an IR signal that the standard DVD player unit 101 can understand. Game control unit 103 requires a one-time initialization process in which game control unit 103 is configured to emulate remote control signals understood by a particular brand and model of DVD player. This initialization process is generally the same process by which any universal remote control is initialized prior to use with a specific DVD player. Brief, such initialization is achieved by matching DVD device 101 with one of the internal codes as supplied in the memory of the remote unit 103 or through the IR receiver on the remote unit 103.

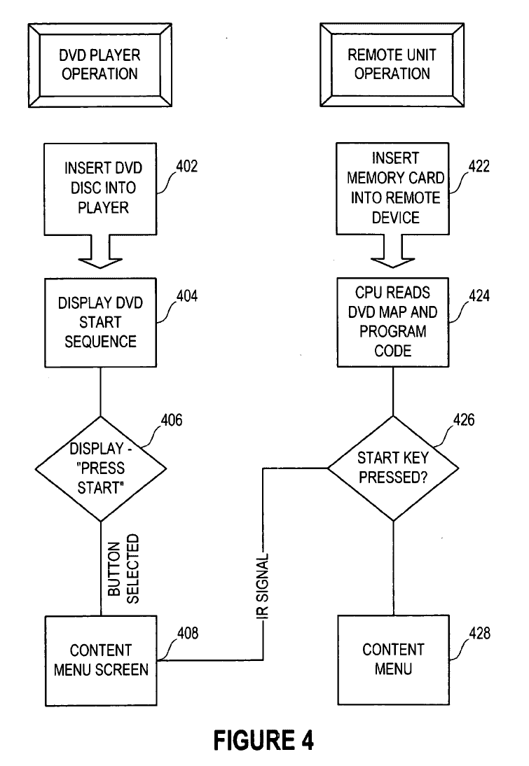

Prior to playing a particular game as defined by data stored on memory device 104 and DVD 106, game control unit 103 synchronizes with DVD player 101 in the manner illustrated in FIG. 4. Such ensures that memory card 104 in remote unit 103 corresponds to the same game as DVD disc 106 in DVD player unit 101. In step 402, the user inserts DVD 106 into DVD player 101. In response, DVD player 101 performs a conventional DVD startup sequence, typically involving display of a welcome presentation and an initial menu from which to select content to play.

Standard DVD navigation requires that a link be present on each menu screen to all content selectable from that menu. This typically takes the form of selectable menu buttons overlaid on a graphical background. Generally, the user navigates the selectable menu buttons using the menu navigation keys 703 to highlight an intended selection.

According to the present invention, the user is not expected, and generally not permitted, to select specific content. Instead, content is selected by logic represented by code 302 of memory device 102. Therefore, the user is presented with a title menu which includes only a text message of “Press Start.” In particular, the appearance of the initial menu as represented on DVD 106 includes only a single visible selection and the selection is associated with the text “Press Start.” This menu has no visible selectable menu buttons and the disk will remain at this point represented as wait step 406 until the appropriate button sequence is pressed. Accordingly, game control unit 103 expects DVD 106 to be waiting at this menu screen when play begins using game control unit 103.

The initial menu of DVD 106 actually includes menu buttons which could be used in a conventional manner to navigate the various clips of multimedia content which are the modules from which the integral gaming experience is crafted by game control unit 103. However, the menu buttons are configured so as to be invisible to the user. An example would be black menu buttons with black text over a black background positioned so as to not obscure the text “Press Start,” in white. However, to access any of these menu buttons, the user would have to blindly guess as to locations of menu buttons containing the active menu on the title menu the button and to blindly navigate to it using repeated presses on the remote control. It is possible to manage such cracking of the content of DVD 106 using a process of trial and error, a process which is akin to manually attempting to cracking a secret number password by entering all possible numerical combinations. While it is generally a good idea to thwart attempts to access content of DVD and/or memory device 104 in unauthorized ways, it is more important to avoid inadvertent malfunctions of the integral game experience because a user has inadvertently inserted an incorrect DVD into DVD player 101, i.e., one which does not correspond to memory device 104 inserted in game control unit 103.

Typical remote controls do not include a key labeled, “Start.” In this illustrative embodiment, keyboard 206 of game control unit 103 includes a key labeled, “Start.” Thus, use of a “Start” key helps ensure that the user is using game control unit 103 to control DVD player. 101 rather than a conventional remote control that may have been distributed along with DVD player 101. Of course, an initial start-up key can have a different label; however, it is preferred that the label of the key be something that is not typically used on remote control units.

Initialization of game control unit 103 begins with step 422 in which the user inserts memory device 104 into memory card reader 209. ROM 203, or alternatively NvRAM 202, includes instructions and/or data which cause CPU 201 to detect insertion of memory device 104 into memory card reader 209 and to read the contents of memory device 104 upon insertion in step 424. The initial behavior of game control unit 103 upon execution of code 302 is awaiting pressing of the “Start” key by the user in step 426. It is presumed that the user presses the “Start” key when directed to do so by the initial menu of DVD 106 as described above. Accordingly, game control unit 103, assumes that the navigation state of DVD 106 is waiting at the startup menu as described above with respect to step 406.

Code 302 is programmed to display an initial multimedia clip to initiate game play. This clip is presented in response to the user's pressing of the “Start” key. To get to the intended initial clip, code 302 causes game control unit 103 to issue successive remote control signals to DVD player 101 to make a selection from the current, invisible menu displayed by DVD player 101 on television 100. For example, consider that the initial clip is accessible by pressing a “down” key on-a conventional remote control three times then pressing an “enter” key. In response to pressing of the “Start” key by the user, code 302 causes media control unit 103 to issue remote control signals emulating three distinct “down” key presses followed by one “enter” key press. Although control is still provided through the IR interface of DVD player 101, game control unit 103 can force the navigation of DVD 106 on the embedded navigation stream data included as a feature consistent with a standard DVD format.

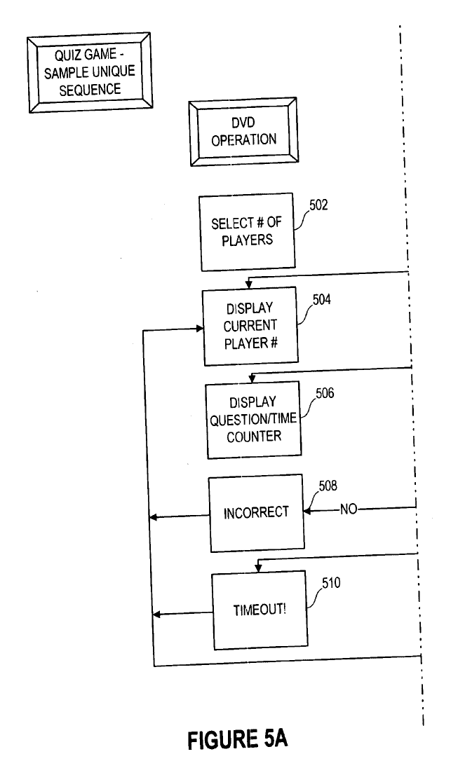

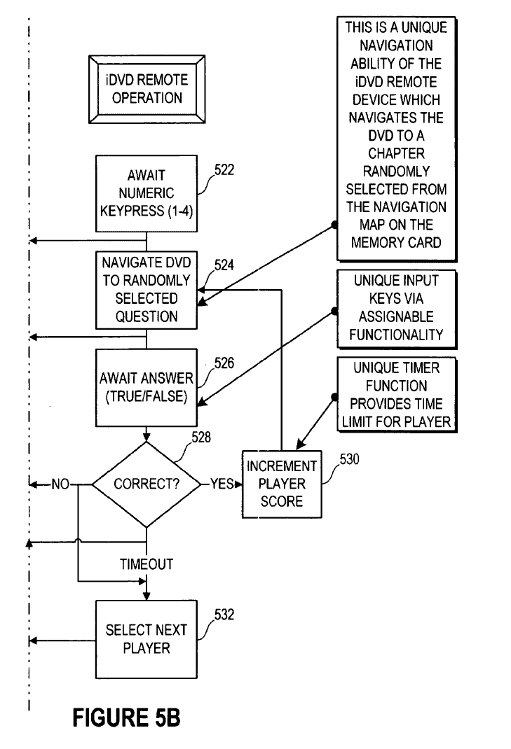

FIG. 5 shows the operation of DVD player unit 101 in conjunction with game control unit 103. In this example, (i) memory device 104 has been inserted into game control unit 103 and DVD 106 has been inserted in DVD player 101, (ii) DVD 106 and memory device 104 correspond to one another and therefore collectively implement the same game, and (iii) the initiation process of FIG. 4 has completed. In the illustrative example of FIG. 5, the subject game, i.e., the game implemented by memory device 104 and DVD 106, is a quiz-type game in which the user is prompted to answer questions.

In this illustrative quiz-type game, the operation of DVD player 101 under control of game control unit 103 allows the user to answer a number of questions randomly selected from a collection of sixty-four (64) questions. To randomly select a question for presentation to the user, code 302 causes CPU 201 to generate a random number to thereby select a question at random. Then, to present the question to the user, code 302 causes game control unit 104 to send remote control signals causing the selected question to be displayed to the user through television 100. DVD 106 represents the questions as thirty-two (32) respective menu buttons organized in a grid of eight (8) columns by four (4) rows, for example, which are not visible to the user. The remote control signals issued by game control unit 103 to initiate play of the selected question are those that the user would ordinarily use to access the representative clip on DVD 106, e.g., <down><down><rig-ht><right><enter> to initiate playback of the question clip associated with the menu button on the third row down and the third column from the left. The button pressed by the user to answer the question does not specify a clip of DVD 106 to be played but instead represents an answer to the recently viewed question. Code 302 interprets the pressed button as either a correct or incorrect answer and selects content to play in response thereto accordingly.

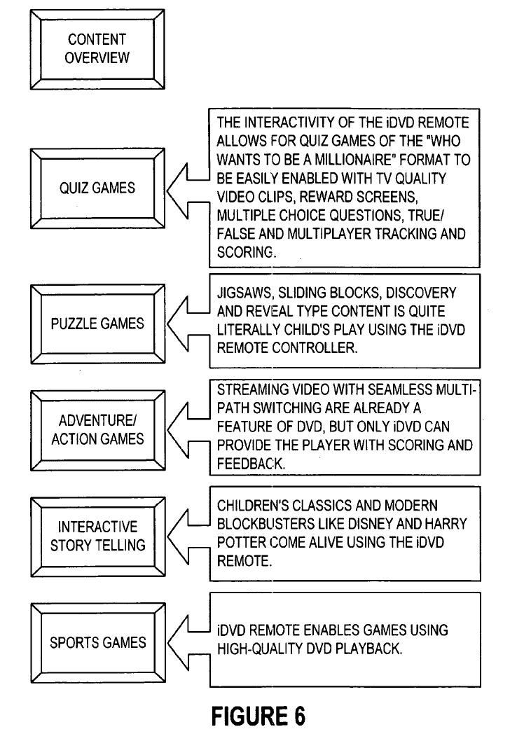

In this manner, code 302 controls display of content of DVD 106 through DVD player 101 on television 100 to portray a mosaic of audiovisual clips which collectively present a full, continuous, audiovisual experience to the user which is adapted in real time to the interaction of the user with media control unit 103. Thus, media control unit 103 is a fully interactive computer device which leverages a full, rich, multimedia user experience of an installed infrastructure of audiovisual equipment. With this configuration in place, the game logic of code 302 can be readily adapted to performed generally any type of game or interactive program. FIG. 6 shows various categories of games that can be configured by appropriate configuration of code 302 and corresponding multimedia content on DVD 106. Of course, the categories shown in FIG. 6 are illustrative only. Other categories can be implemented as well.

FIG. 5 shows the logic of a quiz-type game. In step 502, DVD player 101 displays an initial screen in which the user is prompted to enter a number of players. In step 522, game control unit 103 awaits user input specifying a number of players. Such input can be repeated taps of certain keys of game control unit 103 to increment and/or decrement the number of players. The number of players can be correspondingly incremented/decremented on television 101 by playing corresponding audiovisual clips and/or displaying still images representing the current number of players. When the number of players is specified by the user, game control unit 103 issues remote control signals according to DVD map 301 to cause a current player number to be displayed by television 100 in step 504. In step 524, game control unit 103, in executing code 302, randomly selects a question for presentation to the current player. Game control unit 302 issues remote control signals to DVD player 101 to cause the selected question to be presented through television 100 in step 506. In this illustrative example game, a timer is also shown in the question. The timer can be shown to count down by successively changing a still image which includes the question with a numerical seconds left indicator such that the superimposed seconds left indicator counts down. Alternatively, a seconds left count-down indicator can be superimposed over an audiovisual clip in which the question is posed, e.g., by a recorded image of a person reading the question as if in a television game show.

In step 526, game control unit 103 await input from the user indicating one of a number of possible answers. Such input can indicate such answers as “true” or “false” or, alternatively, as “A,” “B,” “C,” or “D” in a couple of illustrative examples. In this illustrative game example, expiration of the timer is the equivalent of a wrong answer. In step 528, game control unit 103, in executing code 302, determines whether the user input represents a correct response. If so, the current player's score is increased within RAM 205 in step 532. Of course, game control unit 103 can cause content of DVD 106 representing the current player's new score to be displayed on television 100.

If the user's response is incorrect, game control unit 103, in executing code 302, causes content of DVD 106 representing feedback indicating an incorrect response to be displayed on television 100 in step 508. If the incorrect answer is actual a failure to respond before expiration of the timer, an appropriate message as represented in the multimedia content of DVD 106 is displayed in step 510 in response to remote control signals from game control unit 103 so commanding. In this illustrative game, failure to respond in time also causes user selection of the next player in step 530.

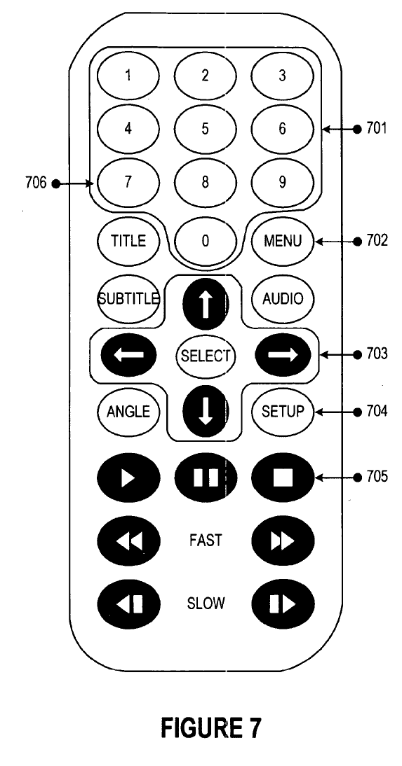

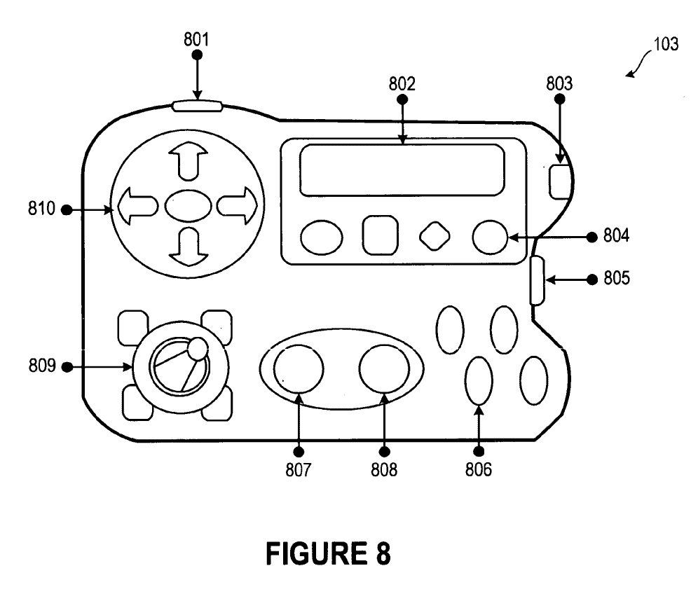

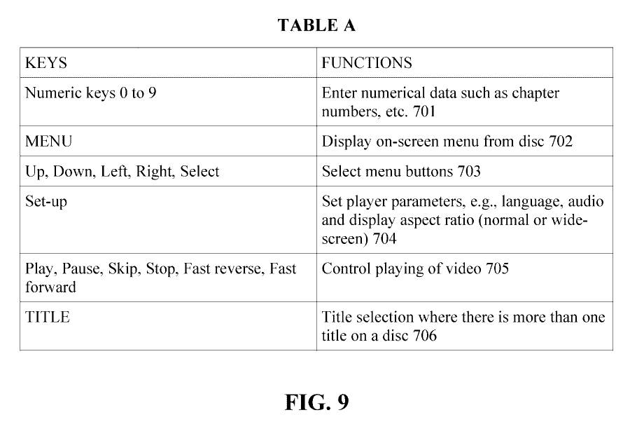

A standard DVD player remote control is depicted in FIG. 7. The DVD Book definition specifies that a standard DVD remote control will include a number of standard buttons for controlling the DVD player as illustrated in Table A of FIG. 9. While game control unit 103, shown in greater detail in FIG. 8, emulates the standard DVD navigation controls 703 using the key grouping 810 for the DVD menu system, game control unit 103 differs significantly in form and therefore function from a standard DVD remote control 700. It should also be appreciated that game control unit 103 differs from a standard DVD remote 700 or a universal remote by the presence of certain clearly defined keys that present unique functionality to the user.

The Custom Function Keys—START 807, RESET 808, and the Application Specific keys 804 provide an example of this extended functionality. For the sake of clarity and ergonomics as well as functionality, certain standard keys from a DVD remote unit 700 are not mimicked on game control unit 103 or are re-labeled in order to better describe their function when used in the context of game control unit 103. These buttons can provide visual and auditory feedback through a small loudspeaker 803 based either on the user's actions in the form of emulated key-clicks or similar key-confirmation sounds or as audio content and/or prompts to the user in accordance with the programming of code 302.

START key 807 on game control unit 103 functions to exit the custom boot sequence upon its completion. This simply navigates the DVD player 101 to the chapter menu that has been designated as the root menu at the time of DVD authoring. This assignment is also supplied to game control unit 103 via memory device 104 inserted in the slot 805 and is unique on each software title.

RESET 808 key restarts execution of code 302 by game control unit 103 and simultaneously resets the DVD player 101 to the start of the custom boot sequence. This has the same effect on the DVD player 101 of pressing the ‘Menu’ or ‘Title’ key on a standard DVD remote control 700.

The Application Specific keys 804 provide contextual and configurable actions to be assigned by the currently executing program on game control unit 103. For example, each button could be assigned a character that would immediately appear to give contextual help in a game, i.e., a hint key in a detective game.

The Key grouping 806 is intended for use in action type games where a ‘fire’ and other reactive type functions need to be represented. The control 809 is an analogue type input where the software needs to represent a real world device that cannot be controlled by a button, such as a golf club. In this example, game control unit 103 makes decisions based on the input from the player—i.e., how hard to hit the ball—and shows the appropriate video sequence via the DVD player 101. A sufficient number of ‘swing’ sequences can be either filmed or computer generated and stored on DVD 106 so that the user gets a reasonable facsimile of their intended action being displayed. This kind of multiple choice outcome mapping requires dozens of outcomes to be depicted and is beyond the specifications of what can be done using only a standard DVD's navigation system. This system could be adapted to emulate a baseball pitcher throwing a user-selected pitch or the timing and/or aim of a batter's swing, for example.

DVD player 101 is a receive-only device in that there is no feedback to any remote device to acknowledge receipt of a command. In normal operation, this is of little consequence as the user can repeatedly press a given key until the user can visually observe that the desired function is executed. The user can also investigate a potential cause of the interference. Typically in an IR setup interference is caused by something obscuring the line of sight between the standard remote control unit and the IR receiver on DVD player 101.

However, in the methodology of the present invention, failure of DVD player 101 to successfully receive a remote control signal from game control unit 103 would cause the executing program to lose synchronization with the navigational state of DVD 106 as perceived by DVD unit 101 navigation relative to its own map of the DVD disc 106 content.

By way of example, if the user was playing a quiz-type program and selected an answer to a quiz question, the executing program on game control unit 101 would advance to the next step based on the user input, but DVD player 101 having not received the signal would still remain at the previous menu. Game control unit 103 would therefore emit feedback such as flashing its lighted buttons to indicate a correct answer and move to a new menu where game control unit 103 would await the user's input. If, in this example, the correct answer were item 4, game control unit 103 would await that menu item to be selected, whereas television 101 would display the previous menu wherein the answer was item 1, for example. At this point, the program executing on game control unit 103 is no longer in synchronization with DVD 106 and apparently random, erroneous results will occur, forcing the user to abandon the game by pressing RESET 808.

For this reason, an RF module 207 on game control unit 103 is provided as the preferred method of communicating with DVD player 101. This is achieved via the RF/IR repeater unit 102. This is permanently located nearby the DVD player unit 101. RF/IR repeater unit 102 receives signals from the remote unit as short range radio waves and translates the RF signal to and emits them as IR codes to DVD player 101. These radio waves may be within the 2.4 GHz range commonly utilized by Bluetooth and WiFi enabled devices. The translation of RF to IR can be fixed such that adaptation to the specific expected signals of DVD player 101 is accomplished within game control unit 103. Alternatively, the RF signals transmitted by game control unit 103 can remain fixed independent of the particular brand and model of DVD player 101 and such adaptation can be accomplished within RF/IR repeater unit 102. The user can place RF/IR repeater unit 102 in a fixed position such that line-of-sight communication between RF/IR repeater unit 102 and DVD player 101 is not subject to interference. Since RF signals do not require line of sight, game control unit 103 can be moved about in enthusiasm without losing communication with DVD player 101.

It should be noted that this is a configuration convenience particularly suited to situations where the user is anticipated to be a young child. An adult or technologically aware user might be sufficiently aware of the operation technology to use a version of game control unit 103 without this intermediary stage thereby reducing the cost of the unit. In this instance, the user would simply press the ‘Back’ key to step back to the previous menu on the remote unit or if the software did completely lose synchronization then press the ‘Reset’ key and both the program on game control unit 103 and DVD player 101 would restart their respective programs.

The above description is illustrative only and is not limiting. For example, while a separate DVD player and television are shown, other multimedia players can be used—including integrated DVD player/television devices. In addition, while wireless remote control signals are described, wired remote control signals—while not currently popular in public use—can also be used. The present invention is defined solely by the claims which follow and their full range of equivalents.

What is claimed is:

1. A method performed by a media control unit for providing an interactive experience with audiovisual content of a DVD that is played by a multimedia player, the method comprising:
(a) receiving, by the media control unit, a user-generated signal that is representative of a response of the user to a first video sequence of the audiovisual content of the DVD that is presented to the user;
(b) in response to the user-generated signal received in said step (a) determining, by the media control unit, one or more media control signals to communicate to the multimedia device that will result in the multimedia player playing an appropriate video sequence of the audiovisual content of the DVD in order to provide to the user an interactive experience with the audiovisual content of the DVD, the appropriate video sequence being one of a plurality of possible video sequences of the audiovisual content of the DVD that are available for presentation to the user subsequent to the first video sequence; and
(c) wirelessly communicating, by the media control unit, for receipt by the multimedia device, the one or more media control signals determined in said step (b) for playing of the appropriate video sequence;
whereby the appropriate video sequence from the DVD is played by the multimedia player in reply to the response of the user in said step (a) and the interactive experience with the audiovisual content of the DVD is provided to the user.

2. The method of claim 1, wherein said step (b) is performed in accordance with logic for navigating the audiovisual content of the DVD based on the user-generated signal received in said step (a), whereby the interactive experience with the audiovisual content of the DVD is provided.

3. The method of claim 2, wherein machine-executable instructions represent the logic for navigating the audiovisual content of the DVD, the machine-executable instructions being specific to the DVD that is played by the multimedia player.

4. The method of claim 3, wherein a memory device that is removably coupled to the media control unit contains the machine-executable instructions representing the logic for navigating the audiovisual content of the DVD, and wherein the media control unit reads the machine-executable instructions from the memory device.

5. The method of claim 1, wherein the method further comprises the step of detecting the insertion of the removable memory device into a card reader of the media control unit.

6. The method of claim 5, wherein the method further comprises reading, by the media control unit, data from the removable memory device upon the detected insertion of the removable memory device into the card reader of the media control unit.

7. The method of claim 1, wherein the one or more media control signals determined in said step (b) comprise standard infrared DVD remote control signals.

8. The method of claim 7, wherein the one or more media control signals determined in said step (b) are wirelessly communicated via infrared transmissions.

9. The method of claim 7, wherein the one or more media control signals determined in said step (b) are wirelessly communicated via radio frequency transmissions to an RF/IR repeater unit.

10. A media control unit that performs the method of claim 1.

11. A remote control unit that performs the method of claim 1.

12. A game control unit that performs the method of claim 1.

13. A handheld game control unit that performs the method of claim 1.

14. The method of claim 1, further comprising, after performing said steps (a)-(c):
(d) receiving, by the media control unit, a user-generated signal that is representative of a response of the user to presentation of the appropriate video sequence for which the media control signals were determined in said step (b);
(e) in response to the user-generated signal received in said step (d), determining, by the media control unit, one or more media control signals to communicate to the multimedia device that will result in the multimedia player playing a subsequent appropriate video sequence of the audiovisual content of the DVD in order to continue to provide to the user an interactive experience with the audiovisual content of the DVD, the subsequent appropriate video sequence being one of a plurality of possible video sequences of the audiovisual content of the DVD that are then available for presentation to the user subsequent to the first video sequence; and
(f) wirelessly communicating, by the media control unit, for receipt by the multimedia device, the one or more media control signals determined in said step (e) for playing the subsequent appropriate video sequence;
whereby the subsequent appropriate video sequence from the DVD is played by the multimedia player in reply to the response of the user of said step (d), and the interactive experience with the audiovisual content of the DVD is continued to be provided to the user.

15. The method of claim 14, wherein the plurality of possible video sequences of said step (b) is different from the plurality of possible video sequences of said step (e).

16. The method of claim 14, wherein said received user-generated signal of said step (a) is identical to said received user-generated signal of said step (d), and wherein the one or more media control signals wirelessly communicated in said step (c) are different from the one or more media control signals wirelessly communicated in said step (f).

17. The method of claim 14, wherein the subsequent appropriate video sequence is dependent upon a detected presence by the game control unit of an object that is removably coupled to the game control unit.

18. The method of claim 14, wherein the subsequent appropriate video sequence is dependent upon the appropriate video sequence of said step (b).

19. A method performed by a game control unit for providing an interactive gaming experience with audiovisual content of a DVD that is played by a multimedia player, the method comprising:
(a) receiving, by the game control unit, a user-generated signal that is representative of an action of the user in a game;
(b) in response to the user-generated signal received in said step (a), determining, by the game control unit, one or more game control signals to communicate to the multimedia device that will result in the multimedia player playing an appropriate video sequence of the audiovisual content of the DVD in order to provide to the user an interactive gaming experience with the audiovisual content of the DVD, the appropriate video sequence being one of a plurality of possible video sequences of the audiovisual content of the DVD that are available for presentation to the user subsequent to the first video sequence, the appropriate video sequence being dependent upon a detected presence by the game control unit of an object that is removably coupled to the game control unit; and
(c) wirelessly communicating, by the game control unit, for receipt by the multimedia device, the one or more game control signals determined in said step (b) for playing of the appropriate video sequence;
whereby the appropriate video sequence from the DVD is played by the multimedia player in response to the action of the user in the game in said step (a), and the interactive gaming experience with the audiovisual content of the DVD is provided to the user.

20. The method of claim 19, further comprising, after performing said steps (a)-(c):
(d) receiving a user-generated signal that is representative of a response of the user in the game to presentation of the appropriate video sequence for which the game control signals were determined in said step (b);
(e) in response to the user-generated signal received in said step (d), determining, by the game control unit, one or more game control signals to communicate to the multimedia device that will result in the multimedia player playing a subsequent appropriate video sequence of the audiovisual content of the DVD in order to continue to provide to the user the interactive gaming experience with the audiovisual content of the DVD, the subsequent appropriate video sequence being one of a plurality of possible video sequences of the audiovisual content of the DVD that are then available for presentation to the user subsequent to the first video sequence; and
(f) wirelessly communicating, by the game control unit, for receipt by the multimedia device, the one or more game control signals determined in said step (e) for playing the subsequent appropriate video sequence;
whereby the subsequent appropriate video sequence from the DVD is played by the multimedia player in response to the action of the user in the game in said step (d), and the interactive gaming experience with the audiovisual content of the DVD is continued to be provided to the user.
